(19) United States
(12) Patent Application Publication
(10) Pub. No.: US 2008/0214690 A1
(43) Pub. Date: Sep. 4, 2008

(54) Grafted Material, and Method of Manufacturing the Same

(76) Inventors: Makoto Komatsu, Kanagawa (JP); Junichi Kanno, Kanagawa (JP)

Correspondence Address: WENDEROTH, LIND & PONACK, L.L.P., 2033 K STREET N. W., SUITE 800, WASHINGTON, DC, 20006-1021, US

(21) Appl. No.: 11/663,927

(22) PCT Filed: Sep. 22, 2005
(86) PCT No.: PCT/JP05/18051

§ 371 Date: Sep. 19, 2007

(30) Foreign Application Priority Data
Sep. 27, 2004 (JP) 2004-279164

(51) Int. Cl. C08J 7/16; C08F 291/18

(52) U.S. Cl. 522/63; 522/64; 522/65; 525/55

(57) ABSTRACT

There is provided a technique for introducing grafted side chains having a narrow molecular weight distribution onto a molded organic polymer substrate, for example polyolefin substrate, while maintaining the form of the substrate. One aspect of the present invention relates to a method of manufacturing a grafted material, comprising the steps of (a) irradiating an organic polymer substrate with ionizing radiation, and then bringing a polymerizable monomer and a polymerization initiating group-introducing agent into contact with the substrate, thus introducing grafted side chains having polymerization initiating groups on ends thereof onto trunk polymer of the substrate, and (b) then bringing a polymerizable monomer into contact with the substrate, thus causing the grafted side chains to grow.

### TECHNICAL FIELD

The present invention relates to a grafted material and a method of manufacturing the same. Specifically, the present invention relates to a technique for introducing grafted side chains having a narrow molecular weight distribution onto a molded organic polymer substrate, for example polyolefin substrate, while maintaining the form of the substrate. Moreover, another aspect of the present invention relates to a technique for introducing grafted side chains at least part of which is formed through living polymerization onto a molded organic polymer substrate, for example polyolefin substrate, while maintaining the form of the substrate. Moreover, still another aspect of the present invention relates to a technique for introducing grafted side chains of a monomer that has been difficult to subject to graft polymerization hitherto onto a molded organic polymer substrate, for example polyolefin substrate, while maintaining the form of the substrate. Furthermore, yet another aspect of the present invention relates to a technique for introducing grafted side chains of a block copolymer form onto a molded organic polymer substrate, for example polyolefin substrate, while maintaining the form of the substrate.

### BACKGROUND ART

Due to being inexpensive and excellent in terms of processability, heat resistance, chemical resistance, mechanical properties and so on, polyolefins such as polyethylene (PE) and polypropylene (PP) are used in a variety of applications processed into forms such as fibers, films, porous membranes, and hollow molded articles. However, due to polyolefins being chemically stable, it has been difficult to give polyolefins functionality, i.e. to chemically modify polyolefins with functional groups or the like. Moreover, it has been very difficult to give molded polyolefin substrates functionality while maintaining the form thereof, this being due to means that can be used being yet more limited.

Methods of giving a molded polyolefin substrate functionality include a method in which functional groups are directly introduced onto the substrate surface by plasma irradiation, sulfonation or the like, a method in which the surface of the substrate is chemically modified with a polymer containing the functional groups through crosslinking polymerization or the like, and a method in which a monomer (polymerizable substance) is graft polymerized onto the polyolefin substrate.

Of these, a so-called radiation-induced graft polymerization method in which the polyolefin is irradiated with ionizing radiation to produce radicals on trunk polymer of the polyolefin substrate, and a polymerizable monomer (grafting monomer) is graft polymerized thereon is a highly versatile method, in that the method can be applied to polyolefin substrates of various forms, and moreover the graft polymerization can be carried out while maintaining the form of the substrate (see Japanese Patent Publication No. 6-55995, and Japanese Patent Application Laid-open No. 1-292174). Moreover, the functional groups manifesting the functionality are covalently bonded to the polyolefin substrate, and hence there is hardly any diffusion or dissociation of these functional groups away from the substrate. Due to such features, various materials manufactured using the radiation-induced graft polymerization method are used, for example, as chemical filters for clean rooms, or filter materials for liquid chemical treatment used in the semiconductor industry (see Japanese Patent Application Laid-open No. 6-142439, and Japanese Patent Application Laid-open No. 2003-251120).

However, the radiation-induced graft polymerization method uses classical radical polymerization, and hence side reactions such as chain transfer and termination of growth of grafted side chains due to disproportionation or crosslinking between the grafted side chains are unavoidable. There has thus been the problem of it being very difficult to control the number (density) and length (molecular weight and molecular weight distribution) of the grafted side chains. Moreover, due to the substrate being hydrophobic, among hydrophilic monomers there are ones that cannot be graft polymerized on alone, and hence there has been the problem that in such a case graft copolymerization in which a readily polymerizable monomer is mixed in must be carried out. Furthermore, the graft polymerization reaction must be carried out immediately after the substrate has been irradiated, and hence in the case of having to store the substrate temporarily due to circumstances of the manufacturing equipment or the like, the substrate must be refrigerated in an inert gas such as nitrogen or argon, which has been troublesome.

In contrast with the above, as the need has increased to precisely control the molecular weight and structure of polymer materials as high performance materials and high added value materials having improved properties and performance, research into living polymerization, and in particular living radical polymerization, enabling polymers having a relatively narrow molecular weight distribution to be obtained has been carried out with vigor in recent years. In living radical polymerization, free radicals at the ends of a polymer are converted into stable covalently bonded ends (dormant species), and hence a bimolecular termination reaction between radicals at ends of growing polymer chains is suppressed, and as a result a polymer having a relatively uniform molecular weight (i.e. a narrow molecular weight distribution) can be obtained. Hitherto, it was thought that with radical polymerization, because the species involved in the growth are highly reactive, it would be impossible to make polymerization of a living type proceed as with cationic polymerization or anionic polymerization. However, since it was discovered by George et al. in 1993 that radical polymerization of styrene proceeds in a living fashion in the presence of the stable radical TEMPO (2,2,6,6-tetramethylpiperidine-1-oxyl), interest in living radical polymerization has increased (see Michael K. George, et al., “Narrow Molecular Weight Resins by a Free-Radical Polymerization Process”, Macromolecules 1993, 26, p. 2987-2988).

As well as the method using a nitroxyl radical such as TEMPO (called SFRP (stable free radical polymerization)), research into living radical polymerization using transition metal complexes is also currently being carried out with vigor. This is a method in which carbon-halogen bonds at the ends of a polymer are reversibly cleaved to produce free radicals using a redox reaction of a transition metal complex. Polymerization proceeds through carbon radicals produced by this method. This reaction system is known as “atom transfer radical polymerization” (ATRP), since halogen atoms are transferred between the ends of the polymer and the metal complex. Through research up to now, it has been found that complexes of metals belonging to groups 7 to 11 of the periodic table such as ruthenium, copper, iron, nickel, rhodium, palladium and rhenium are useful as transition metal complexes to be used in the ATRP method.

In recent years, examples of research into synthesis of grafted polymers having grafted side chains with a narrow molecular weight distribution using the merits of such living radical polymerization have been reported. However, with most of these it has been necessary to carry out molding after the grafted polymer has been synthesized, and there have been very few examples of research in which grafted side chains having a narrow molecular weight distribution are introduced by carrying out living radical polymerization while maintaining the form of the substrate. Even in the case of grafting onto a molded polyolefin, because a high polymerization temperature is required, the graft polymerization is often carried out after melting the polyolefin substrate, and thus the grafted side chains cannot be introduced while maintaining the form of the substrate (see K. Yamamoto, et al., “Living Radical Graft Polymerization of Styrene to Polyethylene with 2,2,6,6-tetramethylpiperidine-1-oxyl”, Polymer Journal, Vol. 33, No. 11, p. 862-867 (2001)). As an example in which grafted side chains are introduced by carrying out living radical polymerization while maintaining the form of the substrate for a molded polyolefin substrate, there is an example in which graft polymerization is carried out after introducing polymerization initiating groups onto a polyethylene porous film using an ultraviolet sensitizer (see K. Yamamoto, et al., “Living Radical Graft Polymerization of Methyl Methacrylate to Polyethylene Film with Typical and Reverse Atom Transfer Radical Polymerization”, Journal of Polymer Science: Part A: Polymer Chemistry, Vol. 40, p. 3350-3359 (2002)). However, the types of monomers to which this method can be applied are limited, and in particular it is very difficult to graft on water-soluble monomers since the surface of the polyolefin substrate is hydrophobic.

On the other hand, there have been several reports of examples of research in which living radical polymerization is carried out to introduce grafted side chains onto a substrate of an inorganic material such as a silicon wafer or silica gel, or cellulose or the like. For example, there has been reported an example in which polymerization initiating groups (sulfonyl chloride groups) are covalently bonded onto a silicon wafer, and then living radical polymerization (atom transfer radical polymerization) is carried out, thus introducing grafted side chains for which the chain length and density are controlled. Moreover, there has been reported an example in which polymerization initiating groups (azo groups) are covalently bonded onto a silicon wafer, and then living radical polymerization is carried out to introduce grafted side chains. However, with these methods, the polymerization initiating groups are introduced onto the surface of the silicon wafer material using functional groups (e.g. hydroxyl groups) present on the surface of the silicon wafer material, and hence application to a chemically inert polyolefin substrate would be very difficult.

### DISCLOSURE OF THE INVENTION

As described above, for the case of a method of introducing grafted side chains onto a molded polyolefin substrate, it has been desired to develop a versatile method that can be applied to various monomers, and according to which grafted side chains having a narrow molecular weight distribution can be introduced while maintaining the form of the substrate and while suppressing side reactions during the graft polymerization reaction.

The present inventors carried out assiduous studies aimed at providing a method enabling grafted side chains having a narrow molecular weight distribution to be introduced onto a molded polyolefin substrate while maintaining the form of the substrate, and as a result accomplished the present invention after discovering that through a method in which grafted side chains are formed on a molded polyolefin substrate using radiation-induced graft polymerization, and at the same time polymerization initiating groups for living radical polymerization are introduced onto the ends of the grafted side chains through the radiation-induced grafting, and then the grafted side chains are caused to grow through living radical polymerization using the introduced polymerization initiating groups, the molecular weight distribution of the grafted side chains can be controlled. That is, one embodiment of the present invention relates to a method of manufacturing a grafted material, comprising irradiating an organic polymer substrate with ionizing radiation, and then bringing a polymerizable monomer and a polymerization initiating group-introducing agent into contact with the substrate, thus introducing grafted side chains having polymerization initiating groups on ends thereof onto trunk polymer of the substrate, and then bringing a polymerizable monomer into contact with the substrate, thus causing the grafted side chains to grow.

That is, the present invention is a method combining both the merit of radiation-induced graft polymerization that application to a molded polyolefin substrate is possible, and the merit of living radical polymerization that grafted side chains having a narrow molecular weight distribution can be introduced. According to the present invention, first a polymerizable monomer is grafted on using radicals produced on the trunk polymer of the organic polymer substrate through irradiation, and at the same time free radicals on the ends of the grafted side chains are trapped and stable covalently bonded species (dormant species) are formed through the initiating group-introducing agent (step 1). Next, living radical polymerization is carried out taking these covalently bonded species as polymerization initiating groups (step 2).

According to the present invention, a grafted polymer that is both physically and chemically homogeneous can be obtained, and in the case that functional groups are introduced onto the grafted side chains, the density of these functional groups can also be made uniform. Moreover, by using different polymerizable monomers (grafting monomers) in above step 1 and step 2, it also becomes possible to introduce block copolymer grafted side chains onto a polyolefin substrate, which has been difficult with conventional methods. Furthermore, by increasing the hydrophilicity of the substrate surface in step 1, it also becomes possible in step 2 to carry out polymerization with an aqueous solution of a hydrophilic monomer, which has been difficult hitherto.

Following is a detailed description of various embodiments of the present invention.

Organic polymer substrates that can be suitably used for manufacturing the grafted material in the present invention include the following, although there is no limitation thereto: polyolefins such as polyethylene and polypropylene; halogenated polyolefins such as PTFE and polyvinyl chloride; and olefin-halogenated olefin copolymers such as an ethylene-tetrafluoroethylene copolymer and an ethylene-vinyl alcohol copolymer (EVA).

Moreover, forms of the organic polymer substrate that can be suitably used in the present invention include fibers, and woven fabrics and nonwoven fabrics which are assemblies of fibers, films, porous membranes, and hollow molded articles (for example hollow fiber membranes). Moreover, with regard to fiber materials, fibers manufactured using a composite of different materials can be used, for example fibers having a core-sheath structure constituted from a core material and a sheath material, or composite twisted fibers. Moreover, with regard to films, ones in which a plurality of layers are laminated together, or ones manufactured with different materials mixed together so as to form a sea-island structure can be used.

In the present invention, as step 1, using a so-called radiation-induced graft polymerization method, the organic polymer substrate is irradiated with ionizing radiation to produce radicals on trunk polymer of the organic polymer substrate, and a polymerizable monomer is grafted on using these radicals, and at the same time free radicals on the ends of the grafted side chains are trapped and stable covalently bonded species (dormant species) are formed through an initiating group-introducing agent.

Radiation that can be used in the radiation-induced graft polymerization includes α rays, β rays, γ rays, an electron beam, and ultraviolet rays; γ rays and an electron beam are particularly suitable for use in the present invention. Moreover, in the case that it is necessary to pattern the grafted side chains on a substrate such as a film, drawing can be carried out using an electron beam or ultraviolet rays narrowed down into a beam. Moreover, in the case of using a patterning mask such as a photomask, it is preferable to select the combination of the mask material and the radiation while giving consideration to the transmittability. In any of these cases, it is preferable to adjust the time period from irradiating with the radiation until bringing the polymerizable monomer and the substrate into contact with one another, and the temperature and the atmosphere when reacting with the polymerizable monomer while giving consideration to the stability of the radicals produced.

Among radiation-induced graft polymerization methods, there are a pre-irradiation graft polymerization method in which the substrate to be subjected to the grafting is irradiated with the radiation in advance, and then the substrate is brought into contact with the polymerizable monomer (grafting monomer) to bring about reaction, and a simultaneous irradiation graft polymerization method in which the irradiation with the radiation is carried out under the presence of both the substrate and the polymerizable monomer; either method can be used in the present invention. However, to suppress production of a homopolymer, the pre-irradiation method is preferably used. Moreover, examples of methods of bringing the polymerizable monomer and the substrate into contact with one another include a liquid phase graft polymerization method in which the polymerization is carried out with the substrate immersed in a solution of the polymerizable monomer, a vapor phase graft polymerization method in which the polymerization is carried out by brining the substrate into contact with a vapor of the polymerizable monomer, and an impregnation vapor phase graft polymerization method in which the substrate is immersed in a solution of the polymerizable monomer, and then the substrate is taken out from the solution and reaction is carried out in the vapor phase; any of these methods can be used in the present invention.

As described above, fibers, or woven/nonwoven fabrics that are an assembly of fibers are suitable materials for use as the organic polymer substrate for manufacturing the grafted material of the present invention; these readily hold a solution of the polymerizable monomer, and hence it is suitable to use the impregnation vapor phase graft polymerization method.

In the present invention, it is a characteristic feature that in the step of introducing the grafted side chains through radiation-induced graft polymerization (above step 1), polymerization initiating groups are introduced at the same time as introducing the grafted side chains. To introduce the polymerization initiating groups, it is preferable to dissolve the grafting monomer and an initiating group-introducing agent (radical trapping agent) in a suitable solvent, and thoroughly de-aerate, and then bring the resulting mixed solution into contact with the irradiated polymer substrate. In this case, the introduction of the initiating groups is carried out at the same time as the introduction of the grafted side chains. Moreover, it is also possible to first introduce the grafted side chains by bringing the irradiated polymer substrate into contact with the grafting monomer, and then introduce the polymerization initiating groups onto the ends of the introduced grafted side chains by bringing a solution of the initiating group-introducing agent into contact with the substrate.

As grafting monomers (polymerizable monomers) that can be used in the radiation-induced graft polymerization of above step 1, any polymerizable monomer having a vinyl group can be used. For example, the following can be used as a grafting monomer in step 1: styrene-type polymerizable monomers such as styrene and chloromethylstyrene; acrylic acid, methacrylic acid, and ester compounds and amide compounds thereof; acrylonitrile, N-vinylpyrrolidone, vinylpyridine, vinyl acetate, and so on. Note that in the case of carrying out living radical polymerization using an aqueous solution of a hydrophilic monomer in the subsequent living radical polymerization (step 2), it is preferable to make the surface of the substrate be hydrophilic in step 1. For this purpose, a monomer having a hydrophilic group such as acrylic acid, acrylamide, dimethylacrylamide, N-vinylpyrrolidone, or dimethylaminoethyl methacrylate can be suitably used as the grafting monomer in step 1.

Note that in the case of carrying out polymerization using an aqueous solution of a monomer in the present invention, the water used as the solvent is not necessarily limited to being pure water, but rather a mixed water-based solvent such as water and methanol or dimethylformamide (DMF) can also be used. Accordingly, a solution of a hydrophilic monomer as above in such a mixed water-based solvent also comes under an “aqueous solution” in the present specification. In the present invention, as compounds that can be used added to water so as to prepare such a mixed water-based solvent, water-soluble alcohols such as methanol, ethanol and 2-propanol, water-soluble ketones such as acetone, and dimethylformamide (DMF), tetrahydrofuran (THF), dimethyl sulfoxide (DMSO) and so on can be preferably used.

Moreover, compounds that can be used as the initiating group-introducing agent (radical trapping agent) in above step 1 are compounds able to introduce a functional group such as a halogen atom or an N,N-dialkyldithiocarbamate group that can bond to free radicals on the ends of the growing chains (grafted side chains), and moreover reversibly undergo cleavage so as to produce a free radical once again. As compounds able to introduce a halogen atom onto the ends of the growing chains, for example transition metal complexes such as transition metal trihalo-bis(triphenylphosphine) complexes such as a trichloro-bis(triphenylphosphine) iron (III) complex, and hexamethyltriethylenetetramine complexes of copper (II) halides such as copper (II) bromide, and also N-halosuccinimides such as N-bromosuccinimide (NBS) can be suitably used, although there is no limitation thereto. Moreover, as compounds able to introduce an N,N-dialkyldithiocarbamate group onto the ends of the growing chains, for example iron (III), copper (II), nickel (II) and ruthenium (III) dialkyldithiocarbamates such as diethyldithiocarbamates can be suitably used, although there is no limitation thereto.

When trying to control the overall molecular weight distribution of the grafted side chains of the ultimately obtained grafted material to be narrow, it is preferable to keep the graft ratio in above step 1 low, and form most of the grafted side chains through the living radical polymerization in subsequent step 2. On the other hand, in the case of using an aqueous solution as the solution of the polymerizable monomer in the living radical polymerization in step 2, it is preferable for the hydrophilic monomer to have been grafted on to an extent such as to have given the surface of the organic polymer substrate sufficient hydrophilicity when the radiation-induced graft polymerization of step 1 is terminated. This control of the graft ratio for the radiation-induced graft polymerization can be carried out, for example, by carrying out the impregnation vapor phase polymerization method, and suitably setting the monomer concentration in the polymerizable monomer solution, and controlling the amount of the polymerizable monomer solution relative to the substrate.

Once the above radiation-induced graft polymerization (step 1) has been completed, it is preferable to wash the grafted substrate as necessary with pure water, acetone, tetrahydrofuran, dichloromethane or the like in accordance with the type of the polymerizable monomer used, thus removing unreacted monomer and so on. Note that for the substrate having the polymerization initiating groups introduced onto the ends of the grafted side chains obtained in step 1, because radicals on the ends of the grafted side chains are trapped by the polymerization initiating groups, the substrate can be stored for a long time even in air at normal temperature, and then be subjected to the subsequent living radical polymerization as it is.

In the present invention, a substrate having thereon grafted side chains onto the ends of which polymerization initiating groups have been introduced is formed through radiation-induced graft polymerization as described above, and is then subjected to growth of the grafted side chains through living radical polymerization (step 2).

In step 2, as the grafting monomer for carrying out the living radical polymerization, as with polymerizable monomers that can be used in step 1, any polymerizable monomer having a vinyl group can be used. Here, if the living radical polymerization in step 2 is carried out using a different polymerizable monomer to the grafting monomer used in step 1, then for example grafted side chains of a block copolymer form can be introduced onto the organic polymer substrate such as a polyolefin substrate. Due to the character of living radical polymerization, grafted side chains for which the molecular weight distribution is controlled to be narrow can be introduced onto the organic polymer substrate such as a polyolefin substrate.

For the living radical polymerization of step 2, the reaction can be carried out by bringing the grafted substrate that has been subjected to step 1 and the polymerizable monomer to be used in the living radical polymerization into contact one another, and then heating, but it is preferable to carry out the polymerization at a lower temperature, and hence the polymerization reaction may be initiated by adding to the system an additive (called a radical extracting agent) that is able to extract from the grafted side chains the polymerization initiating groups that have been introduced onto the ends of the grafted side chains in step 1, and thus reversibly produce free radicals. Radical extracting agents that can be used for this purpose vary according to the type of the polymerization initiating groups introduced onto the ends of the grafted side chains in step 1. For example, in the case that methyl methacrylate is graft polymerized on, and the polymerization initiating groups (chlorine atoms) are introduced using a trichloro-bis(triphenylphosphine) iron (III) complex in step 1, the living radical polymerization can be carried out by bringing a hexamethyltriethylenetetramine (HMTETA) complex of a transition metal halide such as copper (I) bromide, or a 2,2′-bipyridyl complex of a transition metal halide such as copper (I) bromide, and a grafting monomer such as glycidyl methacrylate into contact with the substrate. Moreover, in the case that N-vinylpyrrolidone is graft polymerized on, and the polymerization initiating groups (bromine atoms) are introduced using N-bromosuccinimide in step 1, the living radical polymerization can be carried out by bringing a 2,2′-bipyridyl complex of a transition metal halide such as copper (I) bromide, and a grafting monomer such as lithium styrenesulfonate into contact with the substrate. In step 2, the growth of the grafted side chains proceeds in a living fashion, and hence side reactions are suppressed; as a result, production of a homopolymer can be reduced, and grafted side chains having a narrower molecular weight distribution than hitherto can be introduced. Moreover, as the radical extracting agent for the living radical polymerization, instead of the above compounds, a complex of a metal such a ruthenium, iron, nickel, rhodium or palladium can be used in accordance with the type of the polymerization initiating groups.

The present invention also relates to a grafted material manufactured using the method described above. According to the present invention, grafted side chains are formed on the trunk polymer of an organic polymer substrate such as a polyolefin substrate through living polymerization, which enables formation of polymer chains having a narrow molecular weight distribution, and hence a grafted material having introduced thereon grafted side chains for which the molecular weight distribution is controlled to be narrow can be obtained. That is, one embodiment of the present invention relates to a grafted material characterized by having, on trunk polymer of an organic polymer substrate, grafted side chains for which the molecular weight distribution has been controlled to be narrow. According to the present invention, for example a grafted material having, on the trunk polymer of an organic polymer substrate such as a polyolefin substrate, grafted side chains having a very uniform molecular weight with a molecular weight distribution (M_{w}/Mₙ) of preferably not more than 1.5 can be obtained. Moreover, according to one embodiment of the present invention, by using grafting monomers of different types in the former radiation-induced graft polymerization step and the subsequent living radical polymerization step, a grafted material in which the grafted side chains are of a block copolymer form can be obtained. Moreover, by further carrying out the subsequent living radical polymerization step in a plurality of stages changing the type of the grafting monomer, a grafted material having grafted side chains of a block copolymer form with a plurality of types of monomer units (repeating units) can be obtained.

Various embodiments of the present invention are as follows.

1. A method of manufacturing a grafted material, comprising (a) irradiating an organic polymer substrate with ionizing radiation, and then bringing a polymerizable monomer and a polymerization initiating group-introducing agent into contact with the substrate, thus introducing grafted side chains having polymerization initiating groups on ends thereof onto trunk polymer of the substrate, and (b) then bringing a polymerizable monomer into contact with the substrate, thus causing the grafted side chains to grow.

2. A method of manufacturing a grafted material, comprising (a) irradiating an organic polymer substrate with ionizing radiation while a polymerizable monomer and a polymerization initiating group-introducing agent have been brought into contact with the substrate, thus introducing grafted side chains having polymerization initiating groups on ends thereof onto trunk polymer of the substrate, and (b) then bringing a polymerizable monomer into contact with the substrate, thus causing the grafted side chains to grow.

3. The method according to above item 1 or 2, wherein the organic polymer substrate is made of a material at least part of which comprises a polyolefin.

4. The method according to any one of above items 1 through 3, wherein the polymerizable monomer used in step (a) and the polymerizable monomer used in step (b) are the same.

5. The method according to any one of above items 1 through 3, wherein the polymerizable monomer used in step (a) and the polymerizable monomer used in step (b) are different.

6. The method according to any one of above items 1 through 5, wherein the polymerization initiating group-introducing agent is any of a trihalo-bis(triphenylphosphine) iron (III) complex, a hexamethyltriethylenetetramine complex of a copper (II) halide, an N-halosuccinimide, and an iron (III), copper (II), nickel (II) or ruthenium (III) dialkyldithiocarbamate.

7. The method according to any one of above items 1 through 6, wherein in step (b), the growth reaction of the grafted side chains is carried out by bringing the polymerizable monomer and a radical extracting agent into contact with the substrate.

8. The method according to above item 7, wherein the radical extracting agent is a hexamethyltriethylenetetramine (HMTETA) complex or a 2,2′-bipyridyl complex of a transition metal halide.

9. A method of manufacturing a grafted material, comprising subjecting a grafted material obtained using the method according to any one of above items 1 through 8 to further growth of the grafted side chains by bringing into contact with a polymerizable monomer different to the polymerizable monomer used in step (b).

10. A grafted material, which has, on trunk polymer of an organic polymer substrate, grafted side chains for which the molecular weight distribution has been controlled to be narrow.

11. The grafted material according to above item 10, wherein the molecular weight distribution (M_{w}/Mₙ) of the grafted side chains is not more than 1.5.

12. A grafted material, which has, on trunk polymer of an organic polymer substrate, grafted side chains at least part of which has been formed through living polymerization.

13. The grafted material according to any one of above items 10 through 12, wherein the organic polymer substrate is a polyolefin substrate.

14. The grafted material according to any one of above items 10 through 13, wherein the grafted side chains comprise a block copolymer of at least two different repeating units.

### INDUSTRIAL APPLICABILITY

According to the present invention, grafted side chains having polymerization initiating groups on ends thereof are first introduced onto an organic polymer substrate using a radiation-induced graft polymerization method, and then the grafted side chains are caused to grow through living radical polymerization using the polymerization initiating groups, whereby grafted side chains having a narrow molecular weight distribution (i.e. a uniform chain length) can be introduced onto an inert substrate such as a polyolefin substrate. Consequently, according to the present invention, a grafted material characterized by having, on trunk polymer of an organic polymer substrate, grafted side chains for which the molecular weight distribution has been controlled to be narrow can be manufactured. Moreover, by making the grafting monomer used in the radiation-induced graft polymerization step and the grafting monomer used in the living radical polymerization step be of different types, it becomes possible to introduce grafted side chains of a block copolymer form having a narrow molecular weight distribution onto the trunk polymer of the organic polymer substrate. Moreover, according to the present invention, it becomes possible to introduce grafted side chains obtained from a hydrophilic polymerizable monomer onto a hydrophobic substrate, which has been difficult hitherto.

The present invention will now be described more concretely through the following examples. However, the present invention is not limited by the following description. In the following description, the “graft ratio” is the increase in the weight of the substrate after the graft polymerization relative to before the graft polymerization, expressed in wt %. Moreover, the units “meq/g-R” represent the ion exchange capacity per unit weight of the material.

### EXAMPLE 1

1. Preparation of DMF (dimethylformamide) Solution of Iron (III) Complex

Iron (III) chloride hexahydrate (270.3 mg, 1 mmol) and triphenylphosphine (786.9 mg, 3 mmol) were dissolved in DMF in a 100 mL measuring flask, thus preparing a 0.01 mol/L DMF solution of a trichloro-bis(triphenylphosphine) iron (III) complex.

### 2. Radiation-Induced Graft Polymerization Step

A nonwoven fabric (made by DuPont, trade name Tyvek, mean fiber diameter 0.5 to 10 μm, mean pore size 5 μm, a real density 63 g/m², thickness 0.17 mm) comprising polyethylene fibers was cut to a size of 5.0 cm×5.0 cm, and put into a zipped bag, the air in the bag was replaced with nitrogen and the bag was sealed, and then irradiation was carried out with 150 kGy of γ rays under dry ice.

Methylmethacrylate (10 mL), the 0.01 mol/L iron (III) complex DMF solution prepared as above (10 mL) and DMF (90 mL) were put into a 200 mL recovery flask, and bubbling was carried out with ultra-high-purity argon for 1 hour. One piece of the above irradiated nonwoven fabric (5.0 cm×5.0 cm, 153.9 mg) was put in, a joint and a two-way cock to which high vacuum grease had been applied were attached to the flask, and de-aeration at reduced pressure was carried out for 1 minute, and then reaction was carried out for 1 hour in a 50° C. oil bath. The substrate was then taken out, and was washed with THF (tetrahydrofuran) for 6 hours using a Soxhlet extractor, and then dried for 3 hours at 60° C. in a hot air drier, whereby a methyl methacrylate-grafted nonwoven fabric 1 (259.0 mg) having a graft ratio of 68.3% was obtained.

### 3. Living Radical Polymerization Step

A 0.02 mol/L DMF solution of hexamethyltriethylenetetramine (HMTETA) (40 mL) and methyl methacrylate (10 mL) were put into a 100 mL recovery flask, and bubbling was carried out with ultra-high-purity argon for 40 minutes. Copper (I) bromide (57.4 mg, 0.4 mmol) was added and stirring was carried out for 1 minute, and then a piece of the grafted nonwoven fabric obtained as described above cut to a size of 2.5 cm×2.5 cm (56.0 mg) was put in. A joint and a two-way cock to which high vacuum grease had been applied were attached to the flask, and the inside of the flask was de-aerated at reduced pressure for 1 minute, and then reaction was carried out for 3 hours in an 80° C. oil bath. After the reaction, the substrate was washed with THF for 6 hours using a Soxhlet extractor, and then dried for 3 hours in an oven at 60° C., whereby a methyl methacrylate-grafted nonwoven fabric 2 (72.2 mg) having a graft ratio of 28.9% was obtained.

### EXAMPLE 2

A nonwoven fabric (made by DuPont, trade name Tyvek, mean fiber diameter 0.5 to 10 μm, mean pore size 5 μm, a real density 63 g/m², thickness 0.17 mm) comprising polyethylene fibers was cut to a size of 5.0 cm×5.0 cm, and put into a zipped bag, the air in the bag was replaced with nitrogen and the bag was sealed, and then irradiation was carried out with 150 kGy of γ rays under dry ice.

Methyl methacrylate (10 mL) and DMF (50 mL) were put into a 200 mL recovery flask, and bubbling was carried out with ultra-high-purity argon for 1 hour. N-bromosuccinimide (89.0 mg, 0.5 mmol) and one piece of the above irradiated nonwoven fabric (5.0 cm×5.0 cm, 156.0 mg) were added to the flask, a joint and a two-way cock to which high vacuum grease had been applied were attached to the flask, and de-aeration at reduced pressure was carried out for 1 minute, and then reaction was carried out for 1 hour in a 50° C. oil bath. Washing and drying were carried out as in step 2 of Example 1, whereby a methyl methacrylate-grafted nonwoven fabric 3 (163.1 mg) having a graft ratio of 4.6% was obtained.

The grafted nonwoven fabric obtained was cut to a size of 2.5 cm×2.5 cm (37.6 mg), and grafting with methyl methacrylate was carried out as in step 3 of Example 1 above, whereby a methyl methacrylate-grafted nonwoven fabric 4 (65.5 mg) having a graft ratio of 74.2% was obtained.

### EXAMPLE 3

A 0.02 mol/L DMF solution of hexamethyltriethylenetetramine (HMTETA) (40 mL) and glycidyl methacrylate (10 mL) were put into a 100 mL recovery flask, and bubbling was carried out with ultra-high-purity argon for 40 minutes. Copper (I) bromide (57.4 mg, 0.4 mmol) was added and stirring was carried out for 1 minute, and then a piece of the grafted nonwoven fabric 1 obtained in step 2 of Example 1 above cut to a size of 2.5 cm×2.5 cm (60.4 mg) was put in. A joint and a two-way cock to which high vacuum grease had been applied were attached to the flask, and the inside of the flask was de-aerated at reduced pressure for 1 minute, and then reaction was carried out for 3 hours in an 80° C. oil bath. After the reaction, the substrate was processed as in step 3 of Example 1, whereby a methyl methacrylate/glycidyl methacrylate-grafted nonwoven fabric 5 (78.0 mg) was obtained (the graft ratio for the glycidyl methacrylate was 29.1%).

Sodium sulfite (4.0 g) and sodium hydrogen sulfite (2.0 g) were dissolved in pure water (38 mL) in a 100 mL recovery flask, and IPA (isopropyl alcohol) (6.0 g) was further added. A piece of the grafted nonwoven fabric 5 obtained as described above cut to a size of 2.5 cm×2.5 cm (95.5 mg) was added, and reaction was carried out for 6 hours in a 90° C. oil bath. After the reaction, the substrate was washed with pure water, treated with 1 mol/L hydrochloric acid, and then again washed with pure water, before being dried, whereby a sulfonated nonwoven fabric 6 (109.8 mg) was obtained. The ion exchange capacity of this nonwoven fabric was measured to be 1.1 meq/g-R.

### EXAMPLE 4

### 1. Radiation-Induced Graft Polymerization Step

A nonwoven fabric (made by Kurashiki Textile Manufacturing Co., Ltd., trade name OEX-EF4, fiber diameter 2 denier (mean approximately 15 μm), a real density 60 to 70 g/m², thickness 0.30 to 0.35 mm, permeability 110 to 130 cm³/cm²-sec) comprising high-density polyethylene fibers was cut to a size of 5.0 cm×5.0 cm, and put into a zipped bag, the air in the bag was replaced with nitrogen and the bag was sealed, and then irradiation was carried out with an electron beam (150 kGy).

The above electron beam-irradiated PE nonwoven fabric (5.0 cm×5.0 cm, 161 mg) was immersed in an aqueous solution (w/w=1/1) of N-vinylpyrrolidone (NVP) through which ultra-high-purity argon had been bubbled for 30 minutes. The nonwoven fabric was then put into a glass vessel, a joint and a two-way cock to which high vacuum grease had been applied were attached to the glass vessel, de-aeration at reduced pressure was carried out for 20 seconds, and then reaction was carried out for 2 hours in a constant temperature bath at 60° C. The two-way cock was then opened, a DMF solution of N-bromosuccinimide (NBS) (0.1 mol/L, 20 mL) through which ultra-high-purity argon had been bubbled for 20 minutes was added, and stirring was carried out for 1 hour at room temperature, whereby a radical trapping reaction was carried out. After the reaction, the substrate was rinsed with pure water at room temperature, and was then washed while stirring for 3 hours with pure water (200 mL) at 50° C., before being dried for 3 hours in an oven at 60° C., whereby an NVP-grafted nonwoven fabric 7 (355 mg) having a graft ratio of 120.5% was obtained.

### 2. Living Radical Polymerization Step

Lithium styrenesulfonate (3.8 g, 20 mmol), 2,2′-bipyridyl (125.0 mg, 0.8 mmol) and methanol (10 mL) were dissolved in pure water (30 mL) in a 100 mL recovery flask, and bubbling was carried out with argon for 30 minutes. Copper (I) bromide (57.4 mg, 0.4 mmol) was added and stirring was carried out, and then a piece of the NVP-grafted nonwoven fabric 7 (2.5 cm×2.5 cm, 101.1 mg) obtained as described above was put in. A joint and a two-way cock to which high vacuum grease had been applied were attached to the flask, and the inside of the flask was de-aerated at reduced pressure for 1 minute, and then reaction was carried out for 3 hours in a 50° C. oil bath. The reaction was then stopped by exposing to the air, and after the reaction, the substrate was washed with hydrochloric acid (1 mol/L), and was then washed with pure water, before being dried for 3 hours in an oven at 60° C., whereby a sulfonated grafted nonwoven fabric 8 (118.4 mg) having a graft ratio of 17.1% was obtained.

### EXAMPLE 5

### 1. Radiation-Induced Graft Polymerization Step

The same electron beam-irradiated PE nonwoven fabric as that used in Example 4 (5.0 cm×5.0 cm, 163.0 mg) was immersed in a DMF-water mixed solution (w/w=1/1) of 2-dimethylaminoethyl methacrylate (DMMA) through which ultra-high-purity argon had been bubbled for 30 minutes. The nonwoven fabric was then put into a glass vessel, a joint and a two-way cock to which high vacuum grease had been applied were attached to the glass vessel, de-aeration at reduced pressure was carried out for 20 seconds, and then reaction was carried out for 2 hours in a constant temperature bath at 60° C. The two-way cock was then opened, a DMF solution of N-bromosuccinimide (NBS) (0.1 mol/L, 20 mL) through which ultra-high-purity argon had been bubbled for 20 minutes was added, and stirring was carried out for 1 hour at room temperature, whereby a radical trapping reaction was carried out. After the reaction, the substrate was rinsed with pure water at room temperature, and was then washed while stirring for 3 hours with pure water (200 mL) at 50° C., before being dried for 3 hours in an oven at 60° C., whereby a DMMA-grafted nonwoven fabric 9 (249.4 mg) having a graft ratio of 53.0% was obtained.

### 2. Living Radical Polymerization Step

Sodium styrenesulfonate (4.1 g, 20 mmol), 2,2′-bipyridyl (125.0 mg, 0.8 mmol) and methanol (10 mL) were dissolved in pure water (30 mL) in a 100 mL recovery flask, and bubbling was carried out with argon for 30 minutes. Copper (I) bromide (57.4 mg, 0.4 mmol) was added and stirring was carried out, and then a piece of the DMMA-grafted nonwoven fabric 9 (2.5 cm×2.5 cm, 62.3 mg) obtained as described above was put in. A joint and a two-way cock to which high vacuum grease had been applied were attached to the flask, and the inside of the flask was de-aerated at reduced pressure for 1 minute, and then reaction was carried out for 3 hours in a 50° C. oil bath. The reaction was then stopped by exposing to the air, and after the reaction, the substrate was washed with hydrochloric acid (1 mol/L), and was then washed with pure water, before being dried for 3 hours in an oven at 60° C., whereby a sulfonated grafted nonwoven fabric 10 (68.1 mg) having a graft ratio of 9.3% was obtained.

1. A method for manufacturing a grafted material comprising the steps of (a) irradiating an organic polymer substrate with ionizing radiation, and then bringing a polymerizable monomer and a polymerization initiating group-introducing agent into contact with the substrate, thus introducing grafted side chains having polymerization initiating groups on ends thereof onto trunk polymer of the substrate, and (b) then bringing a polymerizable monomer into contact with the substrate, thus causing the grafted side chains to grow.

2. A method for manufacturing a grafted material comprising the steps of (a) irradiating an organic polymer substrate with ionizing radiation while a polymerizable monomer and a polymerization initiating group-introducing agent have been brought into contact with the substrate, thus introducing grafted side chains having polymerization initiating groups on ends thereof onto trunk polymer of the substrate, and (b) then bringing a polymerizable monomer into contact with the substrate, thus causing the grafted side chains to grow.

3. The method according to claim 1, wherein the organic polymer substrate is made of a material at least part of which comprises a polyolefin.

4. The method according to claim 1, wherein the polymerizable monomer used in step (a) and the polymerizable monomer used in step (b) are the same.

5. The method according to claim 1, wherein the polymerizable monomer used in step (a) and the polymerizable monomer used in step (b) are different.

6. The method according to claim 1, wherein the polymerization initiating group-introducing agent is any of a trihalo-bis(triphenylphosphine) iron (III) complex, a hexamethyltriethylenetetramine complex of a copper (II) halide, an N-halosuccinimide, or dialkyldithiocarbamate of an iron (III) ion, copper (II) ion, nickel (II) ion or ruthenium (III) ion.

7. The method according to claim 1, wherein in step (b), the growth reaction of the grafted side chains is carried out by bringing the polymerizable monomer and a radical extracting agent into contact with the substrate.

8. The method according to claim 7, wherein the radical extracting agent is a hexamethyltriethylenetetramine (HMTETA) complex or a 2,2′-bipyridyl complex of a transition metal halide.

9. The method according to claim 1, wherein in step (a), the surface of the substrate is made hydrophilic by using a polymerizable monomer having a hydrophilic group, and in step (b), the grafted side chains are caused to grow using a hydrophilic polymerizable monomer.

10. A method of manufacturing a grafted material in which a grafted material obtained using the method according to claim 1 is further subjected to further growth of the grafted side chains by being brought into contact with a polymerizable monomer different from the polymerizable monomer used in step (b).

11. A grafted material having, on trunk polymer of an organic polymer substrate, grafted side chains for which the molecular weight distribution has been controlled to be narrow.

12. The grafted material according to claim 11, wherein the molecular weight distribution (M_{w}/Mₙ) of the grafted side chains is not more than 1.5.

13. A grafted material having, on trunk polymer of an organic polymer substrate, grafted side chains at least part of which has been formed through living polymerization.

14. The grafted material according to claim 11, wherein the organic polymer substrate is a polyolefin substrate.

15. The grafted material according to claim 10, wherein the grafted side chains comprise a block copolymer of at least two different repeating units.

16. A grafted material having, on trunk polymer of a hydrophobic organic polymer substrate, grafted side chains constituted from a hydrophilic polymerizable monomer.

17. The method according to claim 2, wherein the organic polymer substrate is made of a material at least part of which comprises a polyolefin.

18. The method according to claim 2, wherein the polymerizable monomer used in step (a) and the polymerizable monomer used in step (b) are the same.

19. The method according to claim 2, wherein the polymerizable monomer used in step (a) and the polymerizable monomer used in step (b) are different.

20. The method according to claim 2, wherein the polymerization initiating group-introducing agent is any of a trihalo-bis(triphenylphosphine) iron (III) complex, a hexamethyltriethylenetetramine complex of a copper (II) halide, an N-halosuccinimide, or dialkyldithiocarbamate of an iron (III) ion, copper (II) ion, nickel (II) ion or ruthenium (III) ion.

21. The method according to claim 2, wherein in step (b), the growth reaction of the grafted side chains is carried out by bringing the polymerizable monomer and a radical extracting agent into contact with the substrate.

22. The method according to claim 21, wherein the radical extracting agent is a hexamethyltriethylenetetramine (HMTETA) complex or a 2,2′-bipyridyl complex of a transition metal halide.

23. The method according to claim 2, wherein in step (a), the surface of the substrate is made hydrophilic by using a polymerizable monomer having a hydrophilic group, and in step (b), the grafted side chains are caused to grow using a hydrophilic polymerizable monomer.

24. A method of manufacturing a grafted material in which a grafted material obtained using the method according to claim 2 is further subjected to further growth of the grafted side chains by being brought into contact with a polymerizable monomer different from the polymerizable monomer used in step (b).

25. The grafted material according to claim 24, wherein the grafted side chains comprise a block copolymer of at least two different repeating units.
